(19) United States
(12) Patent Application Publication
(10) Pub. No.: US 2025/0047505 A1
(43) Pub. Date: Feb. 6, 2025

(54) PUBLIC ITEMIZATION OF PKI NODES (PIPKIN)

(71) Applicant: Wells Fargo Bank, N.A., San Francisco, CA (US)

(72) Inventor: Jeffrey J. Stapleton, O'Fallon, MO (US)

(73) Assignee: Wells Fargo Bank, N.A., San Francisco, CA (US)

(21) Appl. No.: 18/229,731

(22) Filed: Aug. 3, 2023

(51) Int. Cl. H04L 9/32; H04L 9/00

(52) U.S. Cl. CPC H04L 9/3265; H04L 9/006; H04L 9/50

(57) ABSTRACT

The present disclosure is directed to systems, methods, and non-transitory computer-readable media for adding a first Public Itemization of Public Key Infrastructure Nodes (PIPKIN) object to a blockchain, the first PIPKIN object comprises first hierarchy information of at least one first certificate chain of a first Public Key Infrastructure (PKI), and adding a second PIPKIN object to the blockchain, the second PIPKIN object comprises second hierarchy information of at least one second certificate chain of a second PKI.

### BACKGROUND

In a Public Key Infrastructure (PKI), a Certificate Authority (CA) can issue a certificate (e.g., a digital certificate, a public key certificate, and so on) having a subject associated with a subject or a subscriber. In other words, in a PKI, a CA issues a signed certificate associating a subject with a public key. The CA's signature on the certificate binds the CA's name, the subject's name (also called the subscriber), and the subject's public key together, along with other certificate information. A relying party receives the certificate of the subject/subscriber and obtains from the certificate the issuing entity (e.g., the CA), the subject, and the subject public key. The relying party also receives one or more CA certificates to obtain one or more public keys of the PKI in order to validate the certificate chain and verify the certificate of the subscriber. Upon establish trust in the certificate, the subscriber and the relying party can establish other cryptographic keys, exchange or communicate encrypted data, signed messages, digital signatures, and so on.

### SUMMARY

The arrangements disclosed herein relate to systems, methods, non-transitory computer-readable media, and apparatuses for adding a first Public Itemization of Public Key Infrastructure Nodes (PIPKIN) object to a blockchain, the first PIPKIN object comprises first hierarchy information of at least one first certificate chain of a first Public Key Infrastructure (PKI), and adding a second PIPKIN object to the blockchain, the second PIPKIN object comprises second hierarchy information of at least one second certificate chain of a second PKI.

These and other features, together with the organization and manner of operation thereof, will become apparent from the following detailed description when taken in conjunction with the accompanying drawings.

### BRIEF DESCRIPTION OF THE DRAWINGS

FIG. 1 is a schematic diagram illustrating an example method for PKI certificate chain validation, according to various arrangements.

FIG. 2 is a schematic diagram illustrating an example PKI hierarchy, according to various arrangements.

FIG. 3 is a schematic diagram illustrating an example PKI hierarchy, according to various arrangements.

FIG. 4A is a schematic diagram illustrating a standalone PKI, according to various arrangements.

FIG. 4B is a schematic diagram illustrating a cross-certified PKI, according to various arrangements.

FIG. 4C is a schematic diagram illustrating a bridged PKI, according to various arrangements.

FIG. 5 is a schematic diagram illustrating a PIPKIN blockchain storing hierarchy information of PKIs, according to various arrangements.

FIG. 6 is an example pseudocode of a PIPKIN object, according to some arrangements.

FIG. 7 is a schematic diagram illustrating an example system for PIPKIN objects for PKIs using a blockchain, according to various arrangements.

FIG. 8 is a flowchart diagram illustrating an example method for managing PIPKIN objects for PKIs using a blockchain, according to various arrangements.

### DETAILED DESCRIPTION

The arrangements described herein relate to systems, apparatuses, methods, and non-transitory computer-readable media for itemizing PKI hierarchies in a publicly or open accessible environment using Distributed Ledge Technology (DLT) and blockchains. A PKI hierarchy includes nodes and the corresponding Registration Authority (RA). Each of the nodes in the PKI hierarchy can include or represents a CA such as a Root CA (RCA), an Intermediary CA or Subordinary CA (SCA), or Issuing CA (ICA). PKIs can be integrated into a composite blockchain, including standalone PKI, cross-certification between two PKIs, and PKI bridge models. A PKI bridge model allows two PKIs to cross-certify to a third-party CA. In some examples, PKI information is contained in small data blobs that can be published into a publicly accessible blockchain. The blockchain can be permissionless or access controlled.

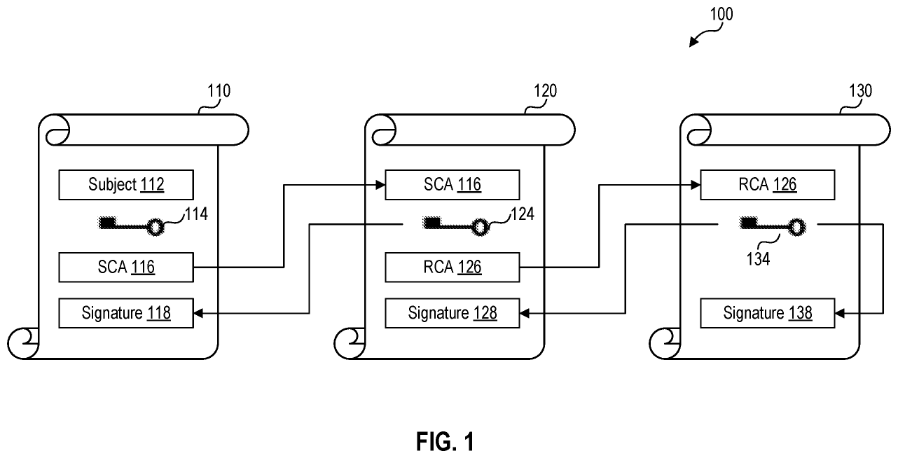

FIG. 1 is a schematic diagram illustrating an example method for PKI certificate chain validation, according to various arrangements. FIG. 1 shows a certificate chain 100 including a subject certificate 110, an SCA certificate 120, and an RCA certificate 130. While the SCA certificate 120 is shown in FIG. 1, other examples may not be implemented with any SCA certificate. The subject certificate 110 is validated through certificate chain validation of the certificate chain 100. The subject certificate 110 is also referred to as an end-entity certificate. In some arrangements, the ICA issues the subject certificate 110, and the RCA issues the ICA certificate and its RCA certificate 130. In some examples, issuing a certificate means a CA signs the certificate with its private key. A relying party can receive the subject certificate 110 from a subscriber.

The subject certificate 110 includes information such as a subject 112, a public key 114, SCA information 116 identifying an SCA, and a signature 118 of the SCA. The subject 112 identifies origin of the certificate 110. The key usage field and extended key usage field are used to indicate the use of a certificate. Examples of the subject 112 includes a name of an individual, company, organization, device, an application, or so on. The subject certificate 110 can be parsed to determine information about the SCA 116. The relying party can obtain the SCA certificate 120, which includes information such as a subject (indicating that the certificate 120 is for the SCA 116), a public key 124 of the SCA, RCA information 126 identifying an RCA, and a signature 128 of the RCA. The SCA certificate 120 can be parsed to determine information about the RCA 126. The relying party can obtain the RCA certificate 130, which includes information such as a subject (indicating that the certificate 130 is for the RCA 126), a public key 134 of the RCA, and a signature 138 of the RCA.

Each of the certificates 110, 120, and 130 includes other information such as validity dates, key usage, and so on. In response to obtaining the certificates 110, 120, and 130, parsing the content in each of the certificates 110, 120, and 130, and verifying certain aspects (e.g., validity dates, key usage, and so on) of the content of each of the certificates 110, 120, and 130, the relying party can perform certificate chain validation by using the public key 134 of the RCA to verify the signature 138 in the RCA certificate 130, using the public key 134 of the RCA to verify the signature 128 in the SCA certificate 120, and using the public key 124 of the SCA to verify the signature 118 included in the subject certificate 110.

Upon successfully completing certificate chain validation, the relying party can use the subject public key 114 per its key usage, including verifying a digital signature, establishing a symmetric key, decrypting ciphertext, and so on. In response to determining that certificate chain validation has failed, the relying party stops trusting the subject certificate.

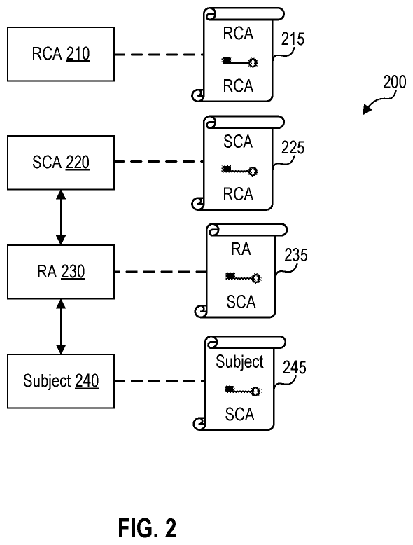

FIG. 2 illustrates an example PKI hierarchy 200, according to various arrangements. The PKI hierarchy 200 can be defined for each certificate chain, e.g., the certificate chain 100. As shown, the PKI hierarchy 200 includes RCA 210, SCA 220, RA 230, subject 240, each of which has a respective one of the certificates 215, 225, 235, and 245.

The subject 240 (e.g., a computing system thereof) generates a public/private key pair, and submits to the RA 230 (e.g., a computing system thereof) a Certificate Signing Request (CSR) including the public key and a signature of the subject 240, generated by signing the public key using the corresponding private key of the subject 240. The subject 240 does not send the CSR directly to the SCA 220 (e.g., a computing system thereof) but rather to the RA 230 which authenticates and authorizes the CSR. In response to the RA 230 authenticating and authorizing the subject, the RA 230 sends a signed CSR, including another signature generated by the RA 230 using a private key of the RA 230. In some examples, the RA certificate is not a part of the certificate chain validation.

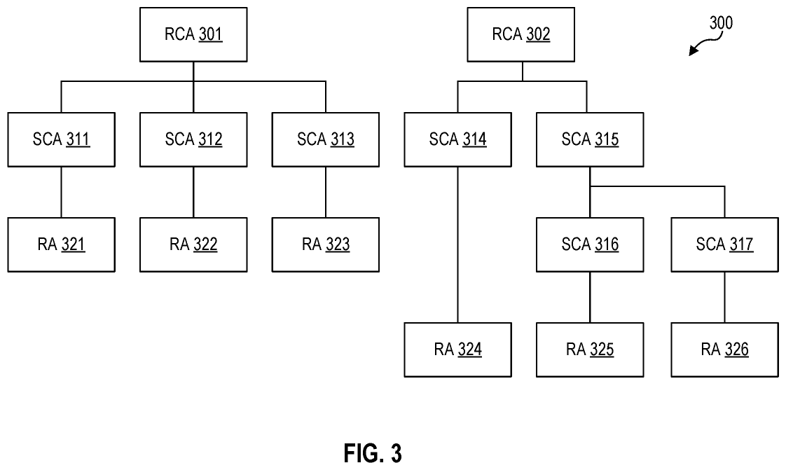

FIG. 3 illustrates an example PKI hierarchy 300, according to various arrangements. The PKI hierarchy 300 include multiple certificate chains. The PKI has two RCAs 301 and 302, each with multiple SCAs 311, 312, 313, 314, 315, 316, and 317 between the RAs 321, 322, 323, 324, 325, and 326 and the RCAs 301 and 302. The RCA 302 has three levels, with two levels of SCAs. In some examples, each of the SCAs 311-317 can be dedicated to different types of certificates, e.g., Transport Layer Security (TLS) certificate, code signing certificate, and so on. Each of the RAs 321-326 can have different authentication and authorization rules. The PKI hierarchy 300 is made up by 6 different certificate chains including a first certificate chain RCA 301 and SCA 311, a second certificate chain RCA 301 and SCA 312, a third certificate chain RCA 301 and SCA 313, a fourth certificate chain RCA 302 and SCA 314, a fifth certificate chain RCA 302, SCA 315, and SCA 316, and a sixth certificate chain RCA 302, SCA 315, and SCA 317.

In some examples, RCA are called roots or trust anchors. Any subordinate CA can be referred to as an SCA signifying that the SCA operates below an RCA. In some examples, RCAs are roots or trust anchors. Any CA between the RCA and ICA are referred to as the SCA. A few PKI structures with more than three levels may distinguish an ICA from an SCA-any system operating between the RCA and the ICA is an SCA. In the example shown in FIG. 3, RCAs 301 and 302 are root CAs, SCA 315 is the only ICA, and all other CAs are SCAs with an RA operating as the SCA front-end.

Given that many CA have long, complicated names (e.g., “Western Funicular Railway Root Certificate Authority 01 Blue Sky”), it is often difficult and resource intensive to determine the CA certificate chains without parsing the actual certificates for the Subject Key Identifier (SKI) and the Authority Key Identifier (AKI), which are hash values of the corresponding public keys. Without actual copies of the certificates, the SKIs and AKIs cannot be verified. Often the CA certificates and the corresponding documents are posted in an online PKI Repository.

Public and private PKIs can host online repositories. Example content of a repository include a list of CA certificates, a Certificate Policy (CP), a Certificate Practice Statement (CPS), and other agreements such as a Subscriber Agreement, a Relying Party Agreement (RPA), third-party Registration Authority Agreement (RAA), and so on. The repository can post audit and assessment information such Webtrust CA, Statement Standard for Attestation Engagements (SSAE) 18 with System and Organization Controls (SOC) reports, Payment Card Industry Data Security Standard (PCI DSS), and so on.

The location of the repository can be included in a X.509 Certificate Policy extension as a link, e.g., an Uniform Record Locator (URL). Some certificates do not include the URL in the extension, while some certificates do not include the extension altogether. The format and style of the repository can be based on the web site style, with different website styles having different formats and styles of the repository. The CA certificates are commonly listed per their names, without any indication of the overall PKI hierarchy. For example, a repository might have nine certificates listed, each being a downloadable certificate file, with nebulous names, such as “Blue Sky,” “Big Mountain,” “Foggy Day,” “Hazy Day,” “Sunny Day,” “Lazy River,” “Little Hill,” “Babbling Brook,” and “Little Stream.” Therefore, the locations, format, style, and names of the repositories are not uniform across different types of certificates, and are difficult to manage.

Although each CA should have unique keys with the public key encoded in a unique certificate, some PKI duplicates the same CA public key in different certificates but with the same names, such that validating the certificate chain can be problematic. Hence, determining the PKI hierarchy from the repository can be difficult.

While the CP or CPS may include some PKI hierarchy information, these documents are typically not kept current, and often have misleading or incorrect information. Further, PKI hierarchies are commonly changed more often than any documentation or the repository gets updated.

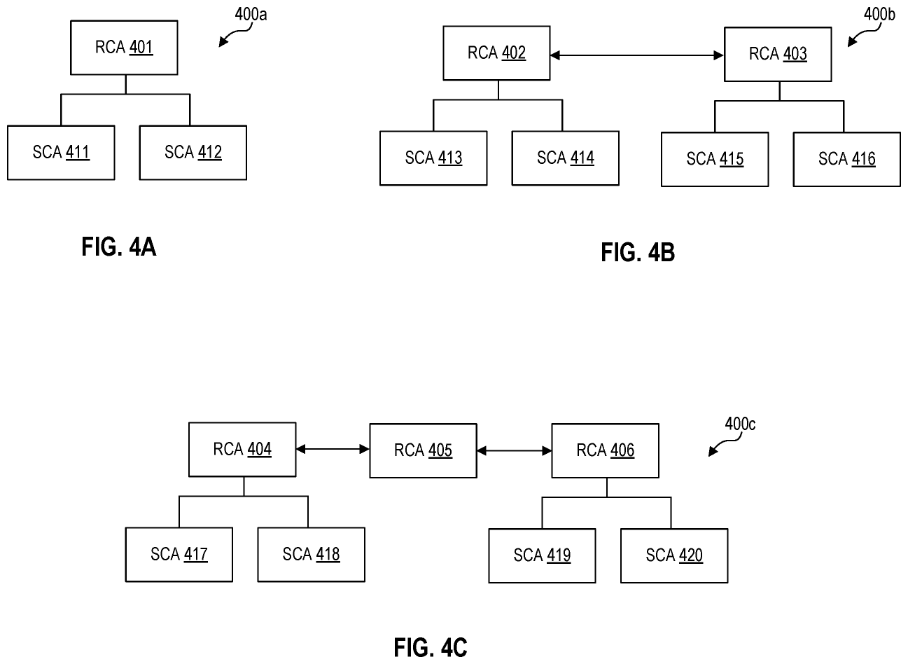

PKIs can be integrated into a composite blockchain that stores hierarchy information for different PKI trust models, such as standalone PKIs, cross-certification between two PKIs, and PKI bridge models. FIG. 4A illustrates a standalone PKI 400a, according to various arrangements. In the standalone PKI 400a, the RCA 401 is the root for two certificate chains, including a first certificate chain RCA 401 and SCA 411 and a second certificate chain RCA 401 and SCA 412.

FIG. 4B illustrates a cross-certified PKI 400b, according to various arrangements. In the cross-certified PKI 400b, the RCA 402 is the root for two certificate chains, including a first certificate chain RCA 402 and SCA 413 and a second certificate chain RCA 402 and SCA 414. The RCA 403 is the root for two certificate chains, including a third certificate chain RCA 403 and SCA 415 and a fourth certificate chain RCA 403 and SCA 416. The RCAs 402 and 403 cross-certify each other.

FIG. 4C illustrates a bridged PKI 400c, according to various arrangements. The bridged PKI (or PKI bridge) model allows two PKIs to cross-certify to a third-party CA. In the bridged PKI 400c, the RCA 404 is the root for two certificate chains, including a first certificate chain RCA 404 and SCA 417 and a second certificate chain RCA 404 and SCA 418. The RCA 406 is the root for two certificate chains, including a third certificate chain RCA 406 and SCA 419 and a fourth certificate chain RCA 406 and SCA 420. The RCAs 404 and 406 cross-certify each other to the third-party RCA 405.

In some arrangements, any public or private PKI can submit one or more Public Itemization of PKI Nodes (PIPKIN) objects to document its hierarchy as a set of CA certificate chains. Each PIPKIN object is published either on a public or private repository, such as a public or private blockchain, a public or private database, and so on. In some examples, PKI information (e.g., hierarchy information) is contained in small data blobs that can be published into a publicly accessible blockchain. The blockchain can be permissionless or access controlled.

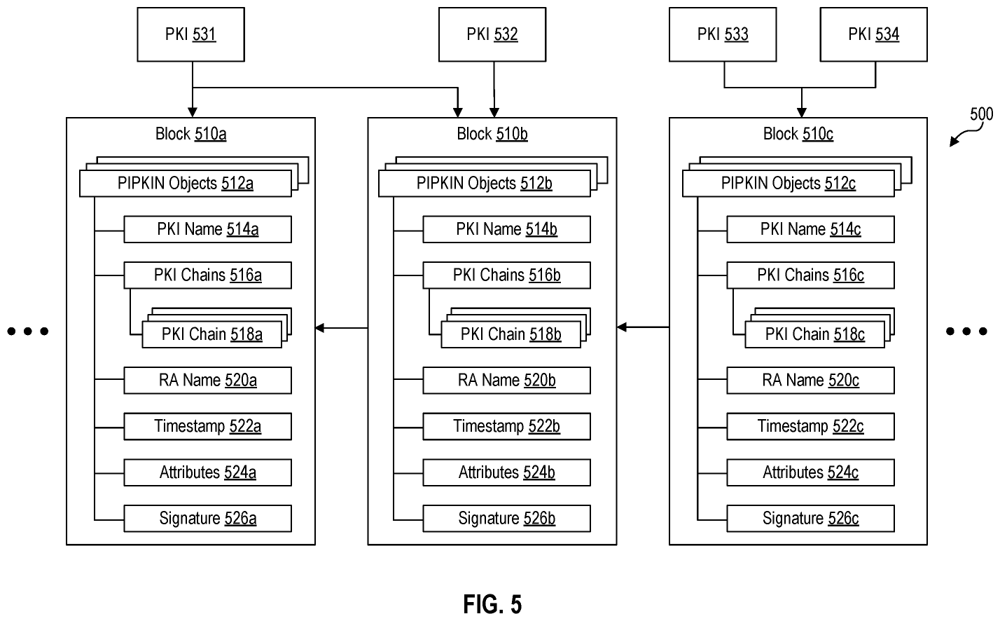

FIG. 5 is a PIPKIN blockchain 500 storing hierarchy information of PKIs 531, 532, 533, and 534, according to various arrangements. The blockchain 500 includes various blocks, examples of which include blocks 510a, 510b, and 510c. The blocks 510a (e.g., N−1), 510b (e.g., N), and 510c (e.g., N+1) are consecutive blocks, such that block 510b is added after block 510a and appended to block 510a, and block 510c is added after block 510b and appended to block 510b. The block 510b includes a link hash of the previous block, which is the block 510a. The block 510c includes a link hash of the previous block, which is the block 510b. The block 510a includes a link hash of the previous block, if any. A block after block 510c includes a link hash of the block 510c.

The block 510a includes at least one PIPKIN object 512a, each PIPKIN object 512a includes at least a PKI name 514a, at least one PKI chain 516a, an RA name 520a, a timestamp 522a, at least one attribute 524a, and a signature 526a. A given PKI can add a respective PIPKIN object 512a (e.g., a PIPKIN record) to the block 510a. For example, the PKI 531 (e.g., a computing system thereof) can add a PIPKIN object 512a to the block 510a. In some examples, the PKI 531 can add the PIPKIN object 512a by sending a request including the information to be added as the content of the PIPKIN object 512a to a blockchain computing system that manages the blockchain 500, and the blockchain computing system can add the block 510a and/or create the PIPKIN object 512a corresponding to the request. The PKI 531 can send the request to the blockchain computing system via any suitable Application Programming Interface (API) or Software Development Kit (SDK) over a suitable network or connection.

Each of the at least one PKI chain 516a is for a given PKI and can be referred to as a PKI chain 518a. Each PKI chain 518a can be defined by two or more CA certificates including two or more of RCA certificate(s), SCA certificate(s), ICA certificate(s), RA certificate(s), subject certificate(s), and so on. The number of each type of certificates and the hierarchical organization of the certificates depends on the certificate trust models, PKIs, and other implementation details. Any of the certificate chains described herein relative to FIGS. 1-4C can be one of the PKI 513 chain 518a.

The PKI name 514a includes at least one name, at least one identifier, or at least one link (e.g., an URL) of the PKI or a computing system thereof that submitted the corresponding PIPKIN object 512c. For example, the PIPKIN object 512a is for the PKI 531 identified by the PKI name 514a. The RA name 520a includes at least one name, at least one identifier, or at least one link (e.g., an URL) of an RA involved in authenticating and authorizing each certificate (e.g., a subject thereof) in the PKI chains 516a.

The timestamp 522a indicates a time by which the PIPKIN object 512a is created. For example, the timestamp 522a can indicate at least one of a time by which the PKI computing system generates the request to add the PIPKIN object 512a, a time by which a blockchain computing system receives the request to add the PIPKIN object 512a from the PKI computing system, a time by which the block 510a is added to the blockchain 500 (e.g., the block 510a is published), a time by which the PIPKIN object 512a is added to the block 510a, and so on. In some examples, the timestamp 522a can include a Trusted Timestamp Token (TST).

The attributes 524a can include various types of information about the PKI chains 516a or the PKI identified by the PKI name 514a, including CP, a CPS, and other agreements such as a Subscriber Agreement, a RPA, third-party RAA, and so on for the chains 516a or the PKI identified by the PKI name 514a. The attributes 524a can include audit and assessment information such Webtrust CA, SSAE 18 with SOC reports, PCI DSS, and so on.

The attributes 524a can include a status indication indicating whether the PIPKIN object 512 or any information contained therein such as the PKI chains 516a is active, inactive (e.g., decommissioned), revoked, or outdated. In some examples, the blockchain computing system can receive information from a third-party computing system that a PKI is decommissioned. In response, the blockchain computing system can indicate in a next block to the blockchain 500 that any PIPKIN object having a PKI name of the decommissioned PKI is decommissioned, by for example including an indication of the same in the attributes field. The status indication can indicate that at the time (indicated by the timestamp 522a) that the PIPKIN object 512 is created, the PKI (identified by the PKI name 514a) or at least one of the PKI chains 516a is new (e.g., not added to the blockchain 500 before). The status indication can indicate that at the time (indicated by the timestamp 522a) that the PIPKIN object 512 is a replacement of a previous PIPKIN object 512 added in an earlier block.

The signature 526a includes cryptographic signature, digital signature, or another suitable signature of the PKI (e.g., the PKI 531 or a computing system thereof) for which the PIPKIN object 512a is created or of the blockchain computing system.

The block 510b includes two or more PIPKIN objects 512b, each PIPKIN object 512b includes at least a PKI name 514b, at least one PKI chain 516b, an RA name 520b, a timestamp 522b, at least one attribute 524b, and a signature 526b. Two or more PKIs can add respective PIPKIN objects 512b (e.g., PIPKIN records) to the block 510b. For example, the PKI 532 (e.g., a computing system thereof) can add a first PIPKIN object 512b to the block 510b. In some examples, the PKI 532 can add the first PIPKIN object 512b by sending a request including the information to be added as the content of the first PIPKIN object 512b to the blockchain computing system that manages the blockchain 500, and the blockchain computing system can add the block 510b and/or create the first PIPKIN object 512b corresponding to the request. The PKI 532 can send the request to the blockchain computing system via any suitable API or SDK over a suitable network or connection.

In addition, the PKI 531 can also update at least one PKI chain (e.g., a PKI chain 518a) previously added to the blockchain 500 (e.g., in block 510a). For example, the PKI 531 (e.g., a computing system thereof) can add a second PIPKIN object 512b to the block 510b. In some examples, the PKI 531 can add the second PIPKIN object 512b by sending a request including the information to be added as the content of the second PIPKIN object 512b and an update indication to the blockchain computing system that manages the blockchain 500, and the blockchain computing system can add the block 510b and/or create the second PIPKIN object 512b corresponding to the request. In some examples, the update indication can include a same name or identifier as that of the PIPKIN object 512a or the PKI chain 518a to which the second PIPKIN object 512b or the PKI chain 518b that replaces the PIPKIN object 512a or the PKI chain 518a.

In some examples, the update indication can include any suitable indication that indicates that a given PIPKIN object 512a or corresponding PKI chain 518a is to be replaced by the new second PIPKIN object 512b or corresponding PKI chain 518b. That is, the block 510b no longer stores any PIPKIN object or PKI chain (previously added to the block 510a) that is replaced and instead stores the new PIPKIN object or PKI chain. The PKI 531 can send the request to the blockchain computing system via any suitable API or SDK over a suitable network or connection.

In some examples, each of the PIPKIN objects 512b corresponds to a given PKI, where the first PIPKIN object 512b is for the PKI 532 and the second PIPKIN object 512b is for the PKI 531. The PIPKIN objects 512b can also include PIPKIN objects added in previously blocks (e.g., block 510a) by other PKIs (e.g., PKI 531) that are not updated.

Each of the at least one PKI chain 516b is for a given PKI and can be referred to as a PKI chain 518b. Each PKI chain 518b can be defined by two or more CA certificates including two or more of RCA certificate(s), SCA certificate(s), ICA certificate(s), RA certificate(s), subject certificate(s), and so on. The number of each type of certificates and the hierarchical organization of the certificates depends on the certificate trust models, PKIs, and other implementation details. Any of the certificate chains described herein relative to FIGS. 1-4C can be the PKI chain 518b.

The PKI name 514b includes at least one name, at least one identifier, or at least one link (e.g., an URL) of the of the PKI or a computing system thereof that submitted the corresponding PIPKIN object 512b. For example, the PIPKIN object 512b is for the PKI 531 or 532 identified by the PKI name 514b. The RA name 520b includes at least one name, at least one identifier, or at least one link (e.g., an URL) of an RA involved in authenticating and authorizing each certificate (e.g., a subject thereof) in the PKI chains 516b.

The timestamp 522b indicates a time by which a PIPKIN object 512b is created. For example, the timestamp 522b can indicate at least one of a time by which the PKI computing system generates the request to add the PIPKIN object 512b, a time by which a blockchain computing system receives the request to add the PIPKIN object 512b from the PKI computing system, a time by which the block 510b is added to the blockchain 500 (e.g., the block 510a is published), a time by which the PIPKIN object 512b is added to the block 510b, and so on. In some examples, the timestamp 522b can include a Trusted TST.

The attributes 524b can be similar to the attributes 524a with respect to the PIPKIN objects 512b. The signature 526b includes can be similar to the signature 526a with respect to the PIPKIN objects 512b.

The block 510c includes two or more PIPKIN objects 512c, each PIPKIN object 512c includes at least a PKI name 514c, at least one PKI chain 516c, an RA name 520c, a timestamp 522c, at least one attribute 524c, and a signature 526c. Two or more PKIs can add respective PIPKIN objects 512c (e.g., PIPKIN records) to the block 510c. For example, the PKI 533 (e.g., a computing system thereof) can add a first PIPKIN object 512c to the block 510c. In some examples, the PKI 533 can add the first PIPKIN object 512c by sending a request including the information to be added as the content of the first PIPKIN object 512c to the blockchain computing system that manages the blockchain 500, and the blockchain computing system can add the block 510c and/or create the first PIPKIN object 512c corresponding to the request. The PKI 533 can send the request to the blockchain computing system via any suitable API or SDK over a suitable network or connection.

The PKI 534 (e.g., a computing system thereof) can add a second PIPKIN object 512c to the block 510c. In some examples, the PKI 534 can add the second PIPKIN object 512c by sending a request including the information to be added as the content of the second PIPKIN object 512c to the blockchain computing system that manages the blockchain 500, and the blockchain computing system can add the block 510c and/or create the second PIPKIN object 512c corresponding to the request. The PKI 534 can send the request to the blockchain computing system via any suitable API or SDK over a suitable network or connection.

In some examples, each of the PIPKIN objects 512c corresponds to a given PKI, where the first PIPKIN object 512c is for the PKI 533 and the second PIPKIN object 512c is for the PKI 534.

The PIPKIN objects 512c can also include PIPKIN objects added in previously blocks (e.g., blocks 510a and 510b) by other PKIs (e.g., PKIs 531 and 532) that are not updated.

Each of the at least one PKI chain 516c is for a given PKI and can be referred to as a PKI chain 518c. Each PKI chain 518c can be defined by two or more CA certificates including two or more of RCA certificate(s), SCA certificate(s), ICA certificate(s), RA certificate(s), subject certificate(s), and so on. The number of each type of certificates and the hierarchical organization of the certificates depends on the certificate trust models, PKIs, and other implementation details. Any of the certificate chains described herein relative to FIGS. 1-4C can be the PKI chain 518c.

The PKI name 514c includes at least one name, at least one identifier, or at least one link (e.g., an URL) of the PKI or a computing system thereof that submitted the corresponding PIPKIN object 512c. For example, the PIPKIN object 512c is for the PKI 533 or 534 identified by the PKI name 514c. The RA name 520c includes at least one name, at least one identifier, or at least one link (e.g., an URL) of an RA involved in authenticating and authorizing each certificate (e.g., a subject thereof) in the PKI chains 516c.

The timestamp 522c indicates a time by which a PIPKIN object 512c is created. For example, the timestamp 522c can indicate at least one of a time by which the PKI computing system generates the request to add the PIPKIN object 512c, a time by which a blockchain computing system receives the request to add the PIPKIN object 512c from the PKI computing system, a time by which the block 510c is added to the blockchain 500 (e.g., the block 510c is published), a time by which the PIPKIN object 512c is added to the block 510c, and so on. In some examples, the timestamp 522c can include a TST.

The attributes 524c can be similar to the attributes 524a with respect to the PIPKIN objects 512c. The signature 526c includes can be similar to the signature 526a with respect to the PIPKIN objects 512c. In some examples, each block (e.g., each of the blocks 510a, 510b, 510c) contains a timestamp 522a, 522b, 522c, respectively, that can be a TST. Each TST contains a hash of the block in which the TST is contained, a Time Stamp Authority (TSA) timestamp, and crypto-binding (e.g., digital signature). In some examples, the TST includes a hash that is computed over all information other than the TST. The TST is appended to all information other than the TST.

An interested party (e.g., a computing system thereof) can check the information stored in a last block of the blockchain 500 to access the most current PIPKIN records from all PKIs including the PKIs 531, 532, 533, and 534.

In some arrangements, each of the PKIs 531, 532, 533, and 534 can include blockchain access information within each CA certificate in a certificate chain (e.g., encoded in the X.509 certificate policies extension). The blockchain access information can include an identifier (e.g., a unique Object Identifier (OID) or a link (e.g., a URL) of the blockchain 500. Any auditor or interested party can access the blockchain 500 to access the latest, most up-to-date block to access the PIPKIN objects for a given PKI. For example, the auditor computing system can retrieve a PIPKIN object according to the PKI name of a PKI of interest, and access the PKI chains of the retrieved PIPKIN object.

Alternatively, a PKI can post the blockchain access information within a repository of the PKI or another database. The auditor computing system can locate the blockchain 500 according to the blockchain access information and retrieve a PIPKIN object according to the PKI name of a PKI of interest, and access the PKI chains of the retrieved PIPKIN object.

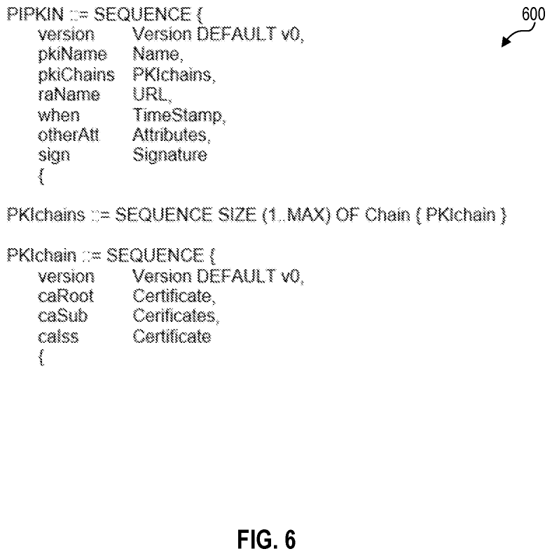

FIG. 6 is an example pseudocode 600 of a PIPKIN object (e.g., the PIPKIN objects 512a, 512b, 512c, and so on), according to some arrangements. The pseudocode 600 representation of the PIPKIN object is defined a sequence of data elements including a version field (with example parameter value “Version DEFAULT v0”), a PKI name field “pkiName” (with example parameter value “Name”), a PKI chains field “pkiChains” (with example parameter value “PKIchains”), a RA name field “raName” (with example parameter value “URL”), a timestamp field “when” (with example parameter value “TimeStamp”), an attribute field “otherAtt” (with example parameter value “Attributes”), and a signature field “sign” (with example parameter value “Signature”). The PKI name field is an example implementation of the PKI names 514a, 514b, and 514c. The PKI chains field is an example implementation of the PKI chains 516a, 516b, and 516c. The RA name field is an example implementation of the RA names 520a, 520b, and 520c. The timestamp field is an example implementation of the timestamps 522a, 522b, and 522c. The attributes field is an example implementation of the attributes 524a, 524b, and 524c. The signature field is an example implementation of the signatures 526a, 526b, and 526c.

The PKI chains field can be further defined by a sequence of data elements 1-MAX each corresponding to a PKI chain of the PKI. The sequence has a sequence size of MAX. For example, the PKI chains field includes at least one PKI chain field (with example parameter “PKIchain”), each of which is an example implementation of PKI chain 518a, 518b, and 518c.

Each PKI chain can be further defined by a sequence of data elements, including a version field (with example parameter “Version DEFAULT v0”) and at least one certificate. The at least one certificate can include a certificate (e.g., the certificate 215) for an RCA (e.g., the RCA 210) in a caRoot field (with example parameter “Certificate”), a certificate (e.g., the certificate 225) for each of one or more SCAs (e.g., the SCA 220) in a caSub field (with example parameter “Certificates”), a certificate for an ICA om a Calss field (with example parameter “Certificate”), a certificate (e.g., the certificate 235) of an RA (e.g., the RA 230), a subject certificate (e.g., the certificate 245) of a subject (e.g., the subject 240). The data element for each of the at least one certificate can include the complete certificate (e.g., the X.509 certificate) or abbreviated information such as an identifier, link (e.g., URL) sufficient to locate or identify the certificate.

In some arrangements, Notary Agent for Public Key Infrastructure Names (NAPKIN) allows individual records (e.g., the blocks 510a, 510b, 510c, the PIPKIN objects 512a, 512b, 512c, and so on) within a blockchain (e.g., the blockchain 500) to be encrypted for privacy or controlled access to groups or individuals. Examples of NAPKIN can be found in at least U.S. Pat. No. 10,547,457, titled “SYSTEMS AND METHODS FOR NOTARY AGENT FOR PUBLIC KEY INFRASTRUCTURE NAMES,” filed Oct. 21, 2016, U.S. Pat. No. 10,848,325, titled “SYSTEMS AND METHODS FOR NOTARY AGENT FOR PUBLIC KEY INFRASTRUCTURE NAMES,” filed Oct. 30, 2019, U.S. Pat. No. 11,677,569, titled “SYSTEMS AND METHODS FOR NOTARY AGENT FOR PUBLIC KEY INFRASTRUCTURE NAMES,” filed Nov. 13, 2020, and U.S. patent application Ser. No. 18/141,912, titled “SYSTEMS AND METHODS FOR NOTARY AGENT FOR PUBLIC KEY INFRASTRUCTURE NAMES,” filed May 1, 2023, the contents of which are incorporated herein by reference in their entireties.

NAPKIN enables a PKI (e.g., a PKI computing system thereof) to publish its repository information in a sequential manner onto a NAPKIN blockchain. The PKI publishes a new CPS and posts the same into a first block of the NAPKIN blockchain. Later, the PKI updates its RPA and posts it into a second block of that blockchain. In response to the PKI deploys a RCA, the PKI updates its CPS and posts it into a third block of the NAPKIN blockchain. In response to the PKI deploys a new SCA, the PKI updates its RPA and posts it into a fourth block of the NAPKIN blockchain. After completing a Webtrust CA audit, the PKI posts an updated audit letter into a fifth block of the NAPKIN blockchain. Due to the auditor findings, the CPS and RPA are updated and posted into a sixth block of the NAPKIN blockchain. The first, second, third, fourth, fifth, and six blocks are posted to the NAPKIN blockchain in that order. Thus, the PKI can be checked by subjects, relying parties, or any potential customer, as to its current operational status.

In some arrangements, Secure Ledger Assurance Token (SLAT) enables a portion of an existing blockchain (e.g., the blockchain 500) to be evaluated and documented. For example, blocks 510a, 510b, and 510c can be evaluated using a first SLAT, while other blocks of the blockchain 500 can be evaluated using one or more other SLATs. The first SLAT provides assurance of the blocks 510a, 510b, and 510c and the other SLATs provide assurance of the other blocks of the blockchain 500.

An auditor or assessor (e.g., a computing system thereof) has evaluated blocks 510a, 510b, and 510c at some point in time and created the first SLAT which contains the cryptographically protected evaluation results. Subsequently, another auditor or assessor (e.g., a computing system thereof) evaluated the other blocks of the blockchain 500 at another point in time and created the one or more other SLATs which contain the cryptographically protected evaluation results for the other blocks of the blockchain 500. The SLAT evaluations (e.g., the SLATs) can themselves constitute another blockchain, sometimes called a side-chain of the original blockchain 500. Thus SLAT is audit-driven over time, possibly on a periodic basis (e.g., annually) or as-needed due to some significant or materially relevant change (e.g., merger, acquisition, divestiture, and so on). SLAT can be used to validate the PKI blockchain history and provide further assurance to subjects, relying parties, or any potential customer, as to its operational integrity.

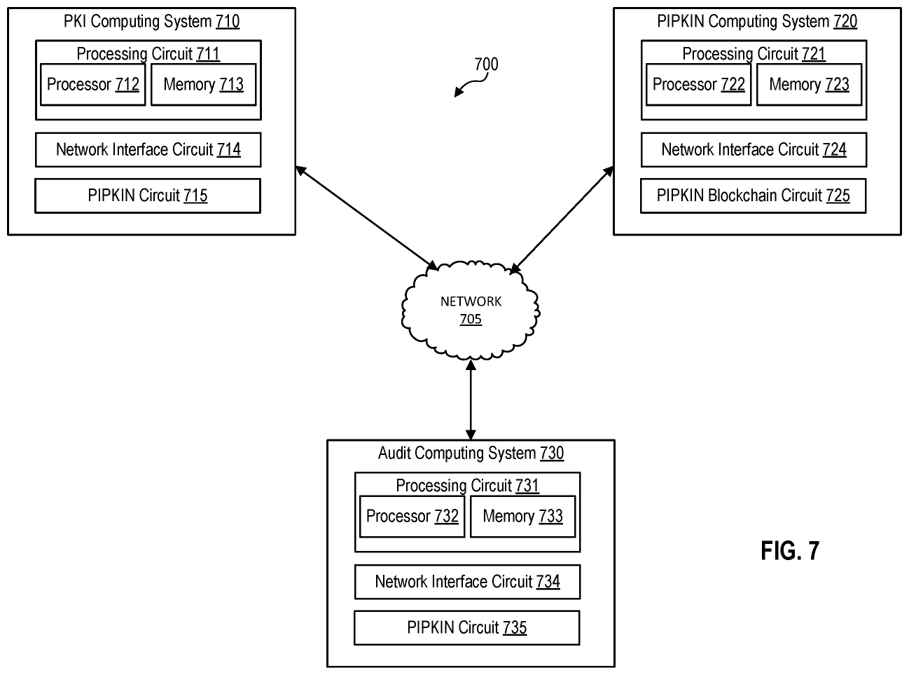

FIG. 7 is a schematic diagram illustrating an example system 700 for PIPKIN objects for PKIs using a blockchain, according to various arrangements. The system 700 includes a PKI computing system 710, a PIPKIN computing system 720, and an audit computing system 730. The PKI computing system 710 is an example of the computing system managing each of PKIs 531, 532, 533, or 534. The PIPKIN computing system 720 can manage a PIPKIN blockchain (e.g., the blockchain 500) or another suitable database or repository storing the PIPKIN objects. The audit computing system 730 is an example of the computing system of an auditor, assessor, user, or another entity interested to audit or otherwise access the hierarchy information of the PKIs as stored by the PIPKIN computing system 720.

The network 705 is any suitable Local Area Network (LAN), Wide Area Network (WAN), or a combination thereof. For example, the network 705 can be supported by Frequency Division Multiple Access (FDMA), Time Division Multiple Access (TDMA), Code Division Multiple Access (CDMA) (particularly, Evolution-Data Optimized (EVDO)), Universal Mobile Telecommunications Systems (UMTS) (particularly, Time Division Synchronous CDMA (TD-SCDMA or TDS) Wideband Code Division Multiple Access (WCDMA), Long Term Evolution (LTE), evolved Multimedia Broadcast Multicast Services (eMBMS), High-Speed Downlink Packet Access (HSDPA), and the like), Universal Terrestrial Radio Access (UTRA), Global System for Mobile Communications (GSM), Code Division Multiple Access 1x Radio Transmission Technology (1x), General Packet Radio Service (GPRS), Personal Communications Service (PCS), 802.11X, ZigBee, Bluetooth, Wi-Fi, any suitable wired network, combination thereof, and/or the like. The network 705 is structured to permit the exchange of data, values, instructions, messages, and the like.

In some arrangements, each of the PIK computing system 710, the PIPKIN computing system 720, and the audit computing system 730 includes a respective processing circuit 711, 721, or 731, having a respective processor 712, 722, or 732 and a respective memory 713, 723, or 733. Each processor 712, 722, or 732 is implemented as a general-purpose processor, an Application Specific Integrated Circuit (ASIC), one or more Field Programmable Gate Arrays (FPGAs), a Digital Signal Processor (DSP), a group of processing components, or other suitable electronic processing components. Each memory 713, 723, or 733 (e.g., Random Access Memory (RAM), Read-Only Memory (ROM), Non-Volatile RAM (NVRAM), Flash Memory, hard disk storage, etc.) stores data and/or computer code for facilitating the various processes described herein. Moreover, each memory 713, 723, or 733 includes tangible, non-transient volatile memory or non-volatile memory. Accordingly, each memory 713, 723, or 733 includes database components, object code components, script components, or any other type of information structure for supporting the various activities and information structures described herein. Each processing circuit 711, 721, or 731 can be used to implemented respective ones of the circuits 714, 715, 724, 725, 734, or 735.

In some arrangements, each of the PIK computing system 710, the PIPKIN computing system 720, and the audit computing system 730 includes a respective network interface circuit 714, 724, or 734. The network interface circuits 714, 724, and 734 can implemented using respective ones of the processing circuits 711, 721, or 731. Each of the network interface circuit 714, 724, or 734 is configured for and structured to establish a connection over the network 705, and allow data, information, messages, and on to be exchanged among the PIK computing system 710, the PIPKIN computing system 720, and the audit computing system 730 over the network 705. Accordingly, each network interface circuit 714, 724, or 734 is structured for sending and receiving data over a communication network (e.g., the network 705). Accordingly, each network interface circuit 714, 724, or 734 includes any of a cellular transceiver (for cellular standards), wireless network transceiver (for 802.11X, ZigBee, Bluetooth, Wi-Fi, or the like), wired network interface, or a combination thereof. For example, each network interface circuit 714, 724, or 734 may include wireless or wired network modems, ports, baseband processors, and associated software and firmware.

In some examples, the PIPKIN circuit 715 of the PKI computing system 710 is configured to perform PIPKIN-related operations of the PKI computing system 710 or an associated PKI as described herein. For example, the PIPKIN circuit 715 can use the network interface circuit 714 to submit a request to add its hierarchy information as PIPKIN objects to the PIPKIN computing system 720 via the network 705.

The PIPKIN blockchain circuit 725 of the PIPKIN computing system 720 is configured to perform PIPKIN-related operations including generating blocks of the blockchain 500, adding PIPKIN objects of one or more PKIs to a block, and so on.

The PIPKIN circuit 735 of the audit computing system 730 is configured to perform auditing or accessing of the PIPKIN objects, including auditing the most recent block on the blockchain 500 and/or using a SLAT to audit hierarchy information of the PKIs, and so on.

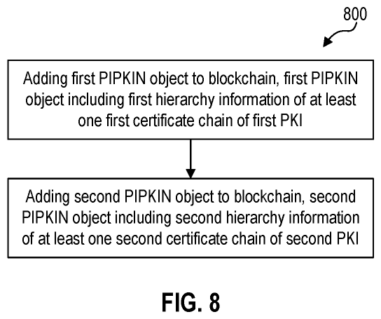

FIG. 8 is a flowchart diagram illustrating an example method 800 for managing PIPKIN objects for PKIs using a blockchain (e.g., the blockchain 500), according to various arrangements. The method 800 can be performed by the system 700. The method 800 can standardize accessing, defining, approving, assuring, disapproving, and managing PKI hierarchy information.

At 810, a first PIPKIN object is added to a blockchain. The first PIPKIN object includes first hierarchy information of at least one first certificate chain of a first PKI. At 820, a second PIPKIN object is added to the blockchain. The second PIPKIN object includes second hierarchy information of at least one second certificate chain of a second PKI.

In some arrangements, adding the first PIPKIN object to the blockchain includes the PIPKIN computing system 720 (e.g., the PIPKIN blockchain circuit 725) publishing the first PIPKIN object to a first block of the blockchain. Adding the second PIPKIN object includes publishing the second PIPKIN object to a second block of the blockchain. In some examples, the first block and the second block are different blocks of the blockchain. In some examples, the second block is added to the blockchain after the first block is added to the blockchain, the first PKI and the second PKI are same, the second hierarchy information is different from the first hierarchy information and is an update to the first hierarch information, and one or more of the at least one first certificate chain is different from one or more of the at least one second certificate chain.

In some examples, the first block and the second block are a same block of the blockchain. In some examples, the first PKI and the second PKI are different PKIs. In some examples, the first PKI and the second PKI are same.

In some examples, the first hierarchy information of the at least one first certificate chain includes a certificate, a link to the certificate, or an identifier of the certificate for each of at least one first CA. In some examples, the second hierarchy information of the at least one second certificate chain includes a certificate, a link to the certificate, or an identifier of the certificate for each of at least one second CA. In some examples, the at least one first CA includes one or more of a first RCA, a first SCA, or a first ICA. In some examples, the at least one second CA includes one or more of a second RCA, a second SCA, or a second ICA.

In some examples, a last block is added to the blockchain, the last block includes most recent hierarchy information of at least one certificate chain of at least one PKI.

In some examples, a certificate in the at least one first certificate chain includes a blockchain access information identifying the blockchain in an extension of the certificate. In some examples, the first PKI stores the blockchain access information identifying the blockchain in a repository of the first PKI.

As utilized herein, the terms “approximately,” “substantially,” and similar terms are intended to have a broad meaning in harmony with the common and accepted usage by those of ordinary skill in the art to which the subject matter of this disclosure pertains. It should be understood by those of ordinary skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

Although only a few arrangements have been described in detail in this disclosure, those skilled in the art who review this disclosure will readily appreciate that many modifications are possible (e.g., variations in sizes, dimensions, structures, shapes, and proportions of the various elements, values of parameters, mounting arrangements, use of materials, colors, orientations, etc.) without materially departing from the novel teachings and advantages of the subject matter described herein. For example, elements shown as integrally formed may be constructed of multiple components or elements, the position of elements may be reversed or otherwise varied, and the nature or number of discrete elements or positions may be altered or varied. The order or sequence of any method processes may be varied or re-sequenced according to alternative arrangements. Other substitutions, modifications, changes, and omissions may also be made in the design, operating conditions and arrangement of the various exemplary arrangements without departing from the scope of the present disclosure.

The arrangements described herein have been described with reference to drawings. The drawings illustrate certain details of specific arrangements that implement the systems, methods and programs described herein. However, describing the arrangements with drawings should not be construed as imposing on the disclosure any limitations that may be present in the drawings.

It should be understood that no claim element herein is to be construed under the provisions of 35 U.S.C. § 112 (f), unless the element is expressly recited using the phrase “means for.”

As used herein, the term “circuit” may include hardware structured to execute the functions described herein. In some arrangements, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some arrangements, a circuit may take the form of one or more analog circuits, electronic circuits (e.g., integrated circuits (IC), discrete circuits, system on a chip (SOCs) circuits, etc.), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

The “circuit” may also include one or more processors communicatively coupled to one or more memory or memory devices. In this regard, the one or more processors may execute instructions stored in the memory or may execute instructions otherwise accessible to the one or more processors. In some arrangements, the one or more processors may be embodied in various ways. The one or more processors may be constructed in a manner sufficient to perform at least the operations described herein. In some arrangements, the one or more processors may be shared by multiple circuits (e.g., circuit A and circuit B may include or otherwise share the same processor which, in some example arrangements, may execute instructions stored, or otherwise accessed, via different areas of memory). Alternatively or additionally, the one or more processors may be structured to perform or otherwise execute certain operations independent of one or more co-processors. In other example arrangements, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some arrangements, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

An exemplary system for implementing the overall system or portions of the arrangements might include a general purpose computing computers in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), a distributed ledger (e.g., a blockchain), etc. In some arrangements, the non-volatile media may take the form of ROM, flash memory (e.g., flash memory such as NAND, 3D NAND, NOR, 3D NOR, etc.), EEPROM, MRAM, magnetic storage, hard discs, optical discs, etc. In other arrangements, the volatile storage media may take the form of RAM, TRAM, ZRAM, etc. Combinations of the above are also included within the scope of machine-readable media. In this regard, machine-executable instructions include, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components, etc.), in accordance with the example arrangements described herein.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative arrangements. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web arrangements of the present disclosure could be accomplished with standard programming techniques with rule based logic and other logic to accomplish the various database searching steps, correlation steps, comparison steps and decision steps.

The foregoing description of arrangements has been presented for purposes of illustration and description. It is not intended to be exhaustive or to limit the disclosure to the precise form disclosed, and modifications and variations are possible in light of the above teachings or may be acquired from this disclosure. The arrangements were chosen and described in order to explain the principals of the disclosure and its practical application to enable one skilled in the art to utilize the various arrangements and with various modifications as are suited to the particular use contemplated. Other substitutions, modifications, changes and omissions may be made in the design, operating conditions and arrangement of the arrangements without departing from the scope of the present disclosure as expressed in the appended claims.

What is claimed is:

1. A system, comprising:
at least one memory; and
at least one processor configured to:
add a first Public Itemization of Public Key Infrastructure Nodes (PIPKIN) object to a blockchain, wherein the first PIPKIN object comprises first hierarchy information of at least one first certificate chain of a first Public Key Infrastructure (PKI); and
add a second PIPKIN object to the blockchain, wherein the second PIPKIN object comprises second hierarchy information of at least one second certificate chain of a second PKI.

2. The system of claim 1, wherein
adding the first PIPKIN object to the blockchain comprises publishing the first PIPKIN object to a first block of the blockchain; and
adding the second PIPKIN object comprises publishing the second PIPKIN object to a second block of the blockchain.

3. The system of claim 2, wherein
the first block comprises a first timestamp;
the second block comprises a second timestamp; and
each of the first timestamp and the second timestamp comprises a Time Stamp Token (TST).

4. The system of claim 3, wherein
the second block is added to the blockchain after the first block is added to the blockchain;
the second hierarchy information is different from the first hierarchy information and includes an update to the first hierarchy information; and
one or more of the at least one first certificate chain is different from one or more of the at least one second certificate chain.

5. The system of claim 1, wherein
adding the first PIPKIN object to the blockchain comprises publishing the first PIPKIN object to a block of the blockchain; and
adding the second PIPKIN object comprises publishing the second PIPKIN object to the same block of the blockchain.

6. The system of claim 1, wherein the first PKI and the second PKI are different PKIs.

7. The system of claim 1, wherein the first PKI and the second PKI are identical.

8. The system of claim 1, wherein
the first hierarchy information of the at least one first certificate chain comprises a certificate, a link to the certificate, or an identifier of the certificate for each of at least one first Certificate Authority (CA); and
the second hierarchy information of the at least one second certificate chain comprises a certificate, a link to the certificate, or an identifier of the certificate for each of at least one second CA.

9. The system of claim 1, wherein
the at least one first CA comprises one or more of a first Root CA (RCA), a first Subordinary CA (SCA), or a first Issuing CA (ICA); and
the at least one second CA comprises one or more of a second RCA, a second SCA, or a second ICA.

10. The system of claim 1, wherein the processor is further configured to add a last block to the blockchain, wherein the last block comprises most recent hierarchy information of at least one certificate chain of at least one PKI.

11. The system of claim 1, wherein
a certificate in the at least one first certificate chain comprises a blockchain access information identifying the blockchain in an extension of the certificate; or
the first PKI stores the blockchain access information identifying the blockchain in a repository of the first PKI.

12. A method, comprising:
adding a first Public Itemization of Public Key Infrastructure Nodes (PIPKIN) object to a blockchain, wherein the first PIPKIN object comprises first hierarchy information of at least one first certificate chain of a first Public Key Infrastructure (PKI); and
adding a second PIPKIN object to the blockchain, wherein the second PIPKIN object comprises second hierarchy information of at least one second certificate chain of a second PKI.

13. The method of claim 1, wherein
adding the first PIPKIN object to the blockchain comprises publishing the first PIPKIN object to a first block of the blockchain; and
adding the second PIPKIN object comprises publishing the first PIPKIN object to a second block of the blockchain.

14. The method of claim 13, wherein
the second block is added to the blockchain after the first block is added to the blockchain; the second hierarchy information is different from the first hierarchy information and includes an update to the first hierarchy information; and
one or more of the at least one first certificate chain is different from one or more of the at least one second certificate chain.

15. The method of claim 12, wherein
the first hierarchy information of the at least one first certificate chain comprises a certificate, a link to the certificate, or an identifier of the certificate for each of at least one first Certificate Authority (CA); and
the second hierarchy information of the at least one second certificate chain comprises a certificate, a link to the certificate, or an identifier of the certificate for each of at least one second CA.

16. The method of claim 12, wherein
the at least one first CA comprises one or more of a first Root CA (RCA), a first Subordinary CA (SCA), or a first issuing CA (ICA); and
the at least one second CA comprises one or more of a second RCA, a second SCA, or a second ICA.

17. The method of claim 12, further comprising adding a last block to the blockchain, wherein the last block comprises most recent hierarchy information of at least one certificate chain of at least one PKI.

18. The method of claim 12, wherein
a certificate in the at least one first certificate chain comprises a blockchain access information identifying the blockchain in an extension of the certificate; or
the first PKI stores the blockchain access information identifying the blockchain in a repository of the first PKI.

19. At least one non-transitory computer-readable medium comprising computer-readable instructions, that, when executed, causes at least one processor to:
add a first Public Itemization of Public Key Infrastructure Nodes (PIPKIN) object to a blockchain, wherein the first PIPKIN object comprises first hierarchy information of at least one first certificate chain of a first Public Key Infrastructure (PKI); and
add a second PIPKIN object to the blockchain, wherein the second PIPKIN object comprises second hierarchy information of at least one second certificate chain of a second PKI.

20. The non-transitory computer-readable medium claim 19, wherein adding the first PIPKIN object to the blockchain comprises publishing the first PIPKIN object to a first block of the blockchain; and
adding the second PIPKIN object comprises publishing the first PIPKIN object to a second block of the blockchain.
